(19) United States
(12) Patent Application Publication
(10) Pub. No.: US 2026/0278308 A1
(43) Pub. Date: Sep. 17, 2026

(54) Alaska Native and Native American Culturally Sensitive Artificial Intelligence Model to Preserve Indigenous Knowledge Systems

(71) Applicant: Elizabeth Ahkivgak, Anchorage, AK (US)

(72) Inventor: Elizabeth Ahkivgak, Anchorage, AK (US)

(21) Appl. No.: 19/080,896

(22) Filed: Mar. 16, 2025

(51) Int. Cl. G06F 40/58; G06N 5/02

(52) U.S. Cl. CPC G06F 40/58; G06N 5/027

(57) ABSTRACT

Disclosed herein introduces a culturally sensitive artificial intelligence (AI) model tailored for Alaska Native and Native American Indigenous cultures. Designed to complement the Culturally Sensitive Language Translation System, the AI model ensures ethical, context-aware language processing and Indigenous Knowledge System preservation. It incorporates Indigenous epistemologies, oral traditions, and community-driven AI governance, fostering an inclusive digital environment. The model prioritizes accuracy, respect, and sovereignty, supporting applications in education, governance, and digital storytelling. By leveraging Indigenous-designed datasets and AI ethics frameworks, this invention strengthens language revitalization, historical preservation, and contemporary cultural expression. It empowers Indigenous communities with AI tools that reflect their values, ensuring equitable technological representation.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This invention relates to artificial intelligence (AI) models specifically designed to support and enhance Indigenous Knowledge Systems within Alaska Native and Native American communities. It focuses on culturally sensitive AI development, ensuring ethical, respectful, and accurate representation of Indigenous languages, traditions, and worldviews. The invention integrates with the previously filed Culturally Sensitive Language Translation System to strengthen AI-driven language preservation and knowledge dissemination.

### Description of the Related Art

The field of this invention lies at the intersection of artificial intelligence, linguistics, and Indigenous Knowledge Systems, focusing on the development of culturally sensitive AI models tailored for Alaska Native and Native American communities. Traditional AI models are primarily designed to process dominant global languages, often neglecting the linguistic and cultural complexities of Indigenous languages. As a result, mainstream AI technologies struggle to accurately translate, preserve, and represent Indigenous linguistic structures and worldviews. This invention aims to bridge that gap by creating an AI model that not only processes Indigenous languages but also incorporates the cultural nuances, oral traditions, and ethical considerations essential to these communities. It represents a shift towards inclusive AI development, ensuring that Indigenous voices and knowledge systems are accurately and respectfully represented in the digital space.

Language is a cornerstone of cultural identity, and for Indigenous communities, the rapid decline of their ancestral languages poses a significant threat to their heritage. According to UNESCO, nearly 40% of the world's languages, many of which belong to Indigenous groups, are at risk of extinction. The National Congress of American Indians (NCAI) has also reported that while approximately 175 Native American languages are still spoken today, many have fewer than 1,000 fluent speakers. This decline is primarily due to historical assimilation policies, lack of language transmission to younger generations, and the absence of Indigenous language support in modern digital tools. The invention of a culturally sensitive AI model addresses this urgent need by leveraging artificial intelligence to support language revitalization, translation accuracy, and digital knowledge preservation. By ensuring Indigenous control over AI development and data governance, this invention empowers communities with the technological tools necessary to preserve their linguistic and cultural heritage for future generations.

The urgency of language preservation is evident through various global and national statistics. UNESCO estimates that one Indigenous language disappears every two weeks, reflecting the ongoing erosion of cultural knowledge. The 2020 U.S. Census revealed that less than 20% of Indigenous individuals speak their ancestral languages at home, underscoring the need for accessible and effective language revitalization tools. Meanwhile, the AI and machine learning industries are projected to grow beyond $500 billion by 2030, yet Indigenous languages remain largely absent from AI datasets and translation models. Studies also indicate that existing AI language models, which are primarily trained on English and other dominant languages, exhibit significant biases when processing Indigenous languages, often leading to inaccurate or misleading translations. Additionally, with the increasing adoption of digital technology among Indigenous youth, there is a unique opportunity to integrate AI-driven language learning and storytelling tools that align with cultural values and traditional knowledge-sharing methods.

Several initiatives have attempted to integrate Indigenous language preservation with technology, but they remain limited in their effectiveness. Google's Woolaroo project and Microsoft's AI for Cultural Heritage have introduced efforts to digitize Indigenous languages and support machine translation. Similarly, organizations such as the First Peoples'Cultural Council in Canada have developed digital applications aimed at language learning. However, these projects often rely on existing AI architectures that do not fully capture the complexities of Indigenous linguistic structures, oral traditions, or cultural epistemologies. Many of these systems use Western linguistic frameworks that fail to recognize the contextual, historical, and ceremonial significance of Indigenous speech patterns. Furthermore, existing AI initiatives do not adequately address ethical concerns such as Indigenous data sovereignty, where communities retain full ownership and control over their linguistic and cultural data. The shortcomings of these projects highlight the need for an Indigenous-led AI development approach, ensuring that language and knowledge systems are preserved in a way that respects community values and governance structures.

This invention introduces a groundbreaking approach by ensuring that artificial intelligence is developed in a way that aligns with Indigenous values and knowledge systems. Unlike conventional AI models, this system integrates Indigenous epistemologies, enabling more accurate and culturally sensitive language processing. The AI model enhances linguistic accuracy by training on Indigenous linguistic structures, incorporating oral storytelling traditions, and allowing for community-led oversight to ensure ethical AI governance. Additionally, it supports multimodal functionality, meaning it can process text, speech, and visual symbols, making it particularly valuable for Indigenous languages that rely on oral traditions and symbolic representations. The invention also upholds Indigenous data sovereignty, allowing communities to manage and control AI training datasets, ensuring that their linguistic and cultural resources are not exploited by external entities. By providing a customizable framework, this AI model enables Indigenous communities to update and refine language processing capabilities to reflect evolving dialects, cultural expressions, and traditional knowledge.

Despite the growing adoption of AI in language processing, Indigenous communities still face significant barriers in accessing and utilizing these technologies effectively. One of the most pressing challenges is the lack of Indigenous language representation in mainstream AI models, making translation systems highly inaccurate or ineffective. Many existing AI models also contain biases that distort Indigenous linguistic expressions, leading to mistranslations or cultural misinterpretations. Moreover, access to AI technology remains limited in many Indigenous communities due to infrastructure challenges, lack of funding, and the absence of culturally relevant digital tools. Another major issue is the ethical concern surrounding data sovereignty, as many AI projects are developed by corporations or institutions that collect and use Indigenous linguistic data without proper consultation or consent from the communities involved. Additionally, mainstream AI models often prioritize written language processing, which does not align with many Indigenous traditions that rely heavily on oral storytelling, ceremonial speech, and intergenerational knowledge transmission. These shortcomings highlight the need for a culturally attuned AI model that not only preserves Indigenous languages but also respects community-led governance and ethical data management.

This invention presents an AI-powered Indigenous Knowledge System designed to support the preservation and revitalization of Alaska Native and Native American languages. Unlike conventional AI models, which primarily focus on dominant global languages, this system is tailored specifically to the linguistic and cultural needs of Indigenous communities. It integrates seamlessly with the previously filed Culturally Sensitive Language Translation System, enhancing the accuracy and reliability of Indigenous language translation while ensuring that AI-generated outputs align with traditional knowledge frameworks. By incorporating Indigenous epistemologies, oral traditions, and ethical AI governance, this invention ensures that AI technology serves as a tool for cultural preservation rather than linguistic erasure. It empowers Indigenous communities by providing them with AI-driven solutions that facilitate language learning, digital storytelling, and knowledge transmission in a culturally respectful manner. Through a community-led approach, this AI model upholds Indigenous data sovereignty, allowing for the ethical management and protection of linguistic and cultural resources.

This invention directly addresses a critical gap in the AI and language translation market by offering a culturally sensitive and ethically governed AI model for Indigenous Knowledge Systems. While mainstream AI models continue to struggle with Indigenous language processing due to insufficient training data and biased algorithms, this invention provides a solution that is designed specifically by and for Indigenous communities. By ensuring Indigenous control over AI development and data sovereignty, it prevents the exploitation of linguistic and cultural resources by external entities. Furthermore, this AI model is adaptable, allowing Indigenous communities to customize features to reflect their unique dialects, storytelling traditions, and ceremonial speech patterns. Unlike existing translation systems that rely solely on textual data, this invention supports multimodal processing, ensuring that oral traditions and visual representations are accurately integrated into AI-generated content. By filling this gap, the invention not only strengthens Indigenous language revitalization efforts but also provides a sustainable and ethical framework for AI development that aligns with Indigenous cultural values. Through this innovation, Indigenous communities can harness AI technology in a way that promotes linguistic preservation, cultural continuity, and digital self-determination in the modern era.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve prior techniques and provide enhanced approach to preserve and revitalize endangered Alaska Native and Native American languages by providing AI-driven language processing and translation.

It is also the objective of the invention to ensure cultural accuracy in AI-generated content by incorporating Indigenous Knowledge Systems and worldviews into the model.

A further objective of the present invention is to empower Indigenous communities with AI tools that support self-determined digital sovereignty and ethical governance.

It is also an object of the invention is to enhance Indigenous education by providing AI-assisted learning resources that align with traditional knowledge and cultural teachings.

It is further the objective of the invention to mitigate biases in mainstream AI systems by designing models that respect Indigenous epistemologies and linguistic structures.

It is also the objective of the invention to provide a platform for Indigenous-led AI development, ensuring that cultural experts and language keepers guide the training and deployment of the AI model.

The objective of the invention is to support digital storytelling and cultural preservation by enabling AI-driven content creation rooted in Indigenous traditions.

It is also the objective of the invention to facilitate cross-generational knowledge transmission by making AI-assisted Indigenous knowledge systems accessible to younger generations.

It is further the objective of the invention to integrate with the Culturally Sensitive Language Translation System, improving AI-assisted communication and translation across Indigenous communities.

The invention aims to ensure that AI technology is developed in a way that respects Indigenous data sovereignty, protecting cultural and linguistic resources from exploitation.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Artificial intelligence has rapidly transformed various industries, including language processing, education, and cultural preservation. However, AI development has largely been centered around dominant global languages, leaving many Indigenous languages and knowledge systems underrepresented. This oversight poses a significant risk to the preservation of linguistic diversity, especially for Alaska Native and Native American communities, whose languages are often oral and deeply intertwined with cultural and historical contexts. The absence of AI models specifically designed to process and respect Indigenous languages has resulted in ineffective translation tools, loss of linguistic heritage, and a lack of access to modern digital resources for Indigenous speakers. To bridge this gap, the development of a culturally sensitive AI model tailored for Indigenous Knowledge Systems is essential, ensuring that these languages and traditions are preserved, accurately represented, and seamlessly integrated into modern digital technologies.

Existing AI translation and natural language processing (NLP) models struggle with Indigenous languages because these languages often do not conform to Western linguistic structures. Unlike widely spoken languages that have extensive digital documentation, Indigenous languages frequently lack standardized writing systems and rely on oral traditions for knowledge transmission. AI models that are trained on mainstream languages typically misinterpret Indigenous linguistic expressions, leading to inaccurate translations and cultural misrepresentation. Furthermore, most AI tools are designed by corporations or institutions without direct collaboration with Indigenous communities, resulting in ethical concerns regarding data sovereignty, ownership, and the commercialization of Indigenous linguistic resources. A culturally sensitive AI model would address these challenges by incorporating Indigenous epistemologies, linguistic structures, and community-led governance into its design, ensuring ethical and accurate AI-driven language processing.

The preservation of Indigenous languages is critical, as language is a carrier of cultural identity, history, and worldviews. Studies indicate that nearly 40% of the world's languages are endangered, many of which belong to Indigenous communities. In the United States, the National Congress of American Indians (NCAI) reports that while approximately 175 Native American languages are still spoken today, most have fewer than 1,000 fluent speakers. The decline of Indigenous languages is largely due to historical policies of assimilation, forced boarding schools, and a lack of institutional support for language transmission. In recent years, there has been a growing movement to revitalize Indigenous languages through education and digital tools, yet most AI-based solutions fail to accommodate the complexities of Indigenous languages. A culturally sensitive AI model would play a crucial role in language revitalization by providing real-time, accurate, and ethically governed translation and learning tools that empower Indigenous speakers and learners.

Despite existing efforts to incorporate Indigenous languages into AI-powered translation and education tools, major shortcomings remain. Some projects, such as Google's Woolaroo and Microsoft's AI for Cultural Heritage, have attempted to support Indigenous language preservation, but these initiatives often rely on AI architectures that are not designed with Indigenous perspectives in mind. Many of these systems use statistical translation methods that do not capture the fluidity of Indigenous linguistic expressions or oral storytelling traditions. Additionally, these projects frequently lack direct collaboration with Indigenous communities, leading to ethical concerns about who controls the data and how it is used. Indigenous data sovereignty is a fundamental issue, as many Indigenous communities have historically been excluded from decision-making processes regarding their linguistic and cultural resources. A truly effective AI model must be developed with Indigenous leadership, ensuring that AI-generated translations and content align with the values, traditions, and knowledge-sharing practices of Indigenous peoples.

The proposed culturally sensitive AI model offers a groundbreaking solution that prioritizes Indigenous-led AI development, ethical governance, and linguistic accuracy. Unlike conventional AI models, this system is trained using Indigenous linguistic structures, oral traditions, and cultural narratives, allowing for more precise translations and contextual understanding. The model also incorporates an adaptive learning mechanism that enables real-time feedback from Indigenous speakers, ensuring continuous improvement and refinement. Additionally, the AI system supports multimodal processing, meaning it can handle not only text but also spoken language, symbolic representations, and visual storytelling elements essential to Indigenous communication. This holistic approach ensures that the AI model is not only a tool for language translation but also a digital repository for cultural preservation, enabling future generations to access and learn their ancestral languages in a meaningful way.

As per its preferred embodiments, one of the key innovations of this AI model is its compliance with Indigenous data sovereignty principles. Unlike mainstream AI translation tools that collect and store data without community oversight, this system is designed to allow Indigenous communities to retain control over their linguistic resources. Through a secure cloud-based or on-premises infrastructure, communities can manage how their data is used, ensuring that translations, AI training datasets, and algorithmic updates remain under their jurisdiction. Additionally, the governance framework includes an Indigenous-led ethics committee that oversees AI development, ensuring that cultural protocols are respected, and that no linguistic data is exploited for commercial purposes. This model aligns with the broader movement toward digital self-determination, where Indigenous communities take an active role in shaping the technologies that impact their cultural and linguistic heritage.

As per further embodiments, this invention offers a transformative solution for Indigenous language preservation and revitalization. The AI model serves as a bridge between traditional knowledge systems and modern digital technologies, empowering Indigenous communities with tools that reflect their linguistic diversity and cultural richness. As more Indigenous communities embrace digital tools for education, governance, and cultural preservation, this AI model provides a sustainable and ethical framework for integrating Indigenous languages into the global digital landscape. Through its culturally sensitive approach, commitment to data sovereignty, and emphasis on linguistic accuracy, this invention ensures that Indigenous languages are not only preserved but also actively used and passed down to future generations in a technologically evolving world.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A culturally sensitive artificial intelligence model for Indigenous Knowledge Systems, comprising:
a machine learning framework trained on Indigenous language datasets, oral traditions, and cultural epistemologies;
a bias mitigation module configured to prevent misrepresentation or distortion of Indigenous cultural knowledge and languages;
an Indigenous data sovereignty mechanism ensuring community-led oversight, access control, and ethical governance of AI-generated outputs; and an adaptive learning system that integrates real-time feedback from Indigenous language experts to enhance linguistic accuracy and cultural appropriateness.
The culturally sensitive artificial intelligence model of claim 1, wherein the machine learning framework is trained using both supervised and unsupervised learning techniques to enhance contextual understanding of Indigenous linguistic expressions.
The culturally sensitive artificial intelligence model of claim 1, further comprising a multimedia support module enabling the integration of visual symbols, traditional artwork, and ceremonial language cues in AI-generated content.

2. A method for integrating a culturally sensitive artificial intelligence model with a language translation system, the method comprising:
processing Indigenous language input using a machine learning model trained on culturally specific linguistic structures;
applying contextual analysis to ensure accurate translation based on cultural and historical relevance;
utilizing a community-driven feedback mechanism to refine and improve translation accuracy over time; and
generating translated outputs in both textual and audio formats that align with Indigenous pronunciation, dialectal variations, and traditional speech patterns.
The method of claim 2, wherein the translation system incorporates phonetic analysis and tone recognition to preserve oral language traditions and Indigenous storytelling techniques.

3. A system for Indigenous community-controlled artificial intelligence development, the system comprising:
a secure cloud-based or on-premises AI infrastructure allowing Indigenous communities to manage AI training datasets and algorithmic updates;
a multilingual AI model supporting Indigenous languages, oral histories, and cultural storytelling methodologies;
a user-interface designed for Indigenous educators, translators, and cultural practitioners to customize AI functionalities; and
a governance framework ensuring compliance with Indigenous data sovereignty principles, including access rights, ethical AI policies, and community review mechanisms.
The system of claim 3, wherein the governance framework includes an Indigenous-led ethics committee to oversee AI development and deployment.
The system of claim 3, further comprising a knowledge-sharing network allowing Indigenous communities to securely exchange AI-driven linguistic and cultural resources while maintaining data sovereignty.
